(19) United States
(12) Patent Application Publication
(10) Pub. No.: US 2012/0296661 A1
(43) Pub. Date: Nov. 22, 2012

(54) SYSTEMS AND METHODS FOR MANAGING HEALTH CARE BILLING AND PAYMENT

(75) Inventors: William T. Lawson, JR., Apex, NC (US); Chris Shoffner, Cary, NC (US); Joseph M. Jenkins, Chapel Hill, NC (US)

(73) Assignee: INNOVADOC LLC, Apex, NC (US)

(21) Appl. No.: 13/466,920

(22) Filed: May 8, 2012

Related U.S. Application Data
(60) Provisional application No. 61/486,517, filed on May 16, 2011.

(51) Int. Cl. G06Q 50/22

(52) U.S. Cl. 705/2

(57) ABSTRACT

Systems and methods for managing health care billing and payment are disclosed. According to an aspect, a method includes defining a health care billing and payment plan for one or more employees and a health care provider. The employees may be employed by the same corporation. The method also includes providing identification cards to the employees. Further, the method includes using one of the cards to transact with the health care provider for health care service provided to one of the employees. The method also includes conducting a payment transaction between the corporation and the health care provider such that the corporation pays for the health care service in accordance with the health care billing and payment plan.

### CROSS REFERENCE TO RELATED APPLICATION

This application claims the benefit of U.S. provisional patent application No. 61/486,517, filed May 16, 2011, the disclosure of which is incorporated herein by reference in its entirety.

### TECHNICAL FIELD

The presently disclosed subject matter relates to health care, and more specifically, to systems and methods for managing health care billing and payment.

### BACKGROUND

Insurance, third party payers, and coding claims for later reimbursement permeate every aspect of health care billing and payment. Current processes involved in billing and payment have become very complex, and current systems lack a point-of-sale (POS) payment platform that incorporates key elements of price transparency, accountability, and flexibility to differentiate providers' services and value. Accordingly, for the foregoing reasons and other reasons, it is desired to provide improved systems and methods for managing health care billing and payment.

### SUMMARY

Systems and methods for managing health care billing and payment are disclosed. According to an aspect, a method includes storing data that defines a health care billing and payment plan between a health care provider and patients associated with the same organization. The method may also include associating a unique identifier with each of the patients. Further, the method may include using the unique identifier of one of the patients to transact with the health care provider for health care service provided to the patient. The method may also include conducting a transaction between the organization and the health care provider such that the organization is billed for the health care service in accordance with the health care billing and payment plan. The method may be implemented by one or more processors of a suitable computing system.

In another aspect, each of the patients may be provided a unique identification card including the unique identifier associated with the respective patient. The identification card may be distributed by the organization to the patients. The patients may be employed by the organization.

In another aspect, a health care billing and payment plan may define fees at which the organization has agreed to pay the health care provider for health care services provided to the patients. The terms of the plan may be negotiated between the health care provider and the organization.

According to another aspect, a transaction may include transferring funds from a financial account of the organization to a financial account of the health care provider for payment of the health care service.

According to another aspect, outcome and patient satisfaction data may be collected from the health care provider. Further, outcome analysis and quality of service reports may be generated based on the data.

According to another aspect, payment may be received from the organization for the billed health care service.

According to another aspect, storing data that defines a health care billing and payment plan between multiple health care providers and one or more patients. The method may also include associating a unique identifier with one of the patients. Further, the method may include using the unique identifier to transact with one of the health care providers for health care service provided to the patient. The method may also include conducting a transaction between the patient and the one of the health care providers such that the patient is billed for the health care service in accordance with the health care billing and payment plan. The method may be implemented by one or more processors of a suitable computing system.

According to another aspect, a processor may be used for implementing one or more steps of the present disclosure.

### BRIEF DESCRIPTION OF THE DRAWINGS

FIG. 1 is a block diagram of an example computing system 100 for managing health care billing and payment in accordance with embodiments of the presently disclosed subject matter;

FIG. 2 is a flowchart of a method that may be implemented by a health care plan manager in accordance with embodiments of the present disclosure;

FIG. 3 is a flowchart of another method that may be implemented by a health care plan manager in accordance with embodiments of the present disclosure;

FIG. 4 depicts an example screenshot for providing interface with information of organizations associated with the health care provider;

FIG. 5 depicts an example screenshot for providing interface with information of a specific organization associated with the health care provider;

FIG. 6 depicts an example screenshot presented subsequent to an Identification or Access Cards icon being selected for one of the individuals shown in FIG. 5;

FIG. 7 depicts an example screenshot of a health care billing and payment plan between an individual and an organization;

FIG. 8 depicts an example screenshot of visits scheduled with a health care provider;

FIG. 9 depicts an example screenshot of billable items associated with a plan of a health care provider;

FIG. 10 depicts an example screenshot of pending identification cards associated with a plan of a health care provider; and

FIG. 11 depicts an example screenshot of invoices associated with a plan of a health care provider.

### DETAILED DESCRIPTION

Exemplary systems and methods for managing health care billing and payment in accordance with embodiments of the presently disclosed subject matter are disclosed herein. In accordance with an aspect, the present subject matter accommodates fee for service POS transactions, subscription payments, and identification of a patient's medical home physician utilizing an identification card. The identification card may specify a unique identifier for a patient. In an example, a patient may acquire an identification card by direct purchase or through his or her employer or other organization.

Systems and methods in accordance with the presently disclosed subject matter may be used to enhance accountability for both patient and physician by embedding a clinical outcomes module within its scaffolding. By combining its flexible payment component with clinical outcomes for chronic disease elements, systems and methods disclosed herein may tie payment and clinical result together. For example, the physician's performance in the care of chronic disease can be compared against his or her peer group using stored data. The patient's success in achieving health-related goals may result in rewards based upon a benefits plan and administered through an identification card in accordance with embodiments disclosed herein. Outcomes reporting can allow employers to effectively manage an incentive platform and more effectively purchase primary care for employees improving and managing their chronic conditions.

In other aspects, systems disclosed herein may include a cash management module configured to enable a health care provider to bring transparency in pricing to its patients and better manage finances of its practice. The cash management module drives a daily process of reconciling expected and realized cash flow as a result of payments from patients and third party payers. By combining transparent pricing, an alternative technique for payment, and a daily process to ensure integrity of financial data, health care providers are empowered to focus more on the patient rather than billing and collections.

Various aspects, features, and/or functions disclosed herein may be combined in any suitable way. Particularly, for example, the POS capability, patient/health care provider identification feature, and clinical outcomes and cash management functions disclosed herein may be combined in any suitable manner for improving health care providers' and patients' lives.

Systems and methods disclosed herein may provide a combination of workflows and features that enable cost-effective, patient-focused, transparently priced, and high quality primary care. In embodiments of the present disclosure, systems and methods may provide one or more of the following features: a POS transaction processing system for health care providers that attaches the patient to his or her medical home; a product definition system that helps medical providers to design their own subscription-based medical service offerings that can then be sold to individuals and groups of patients; a payment platform to support the bulk purchase of primary care services by employers and group purchasers; a reimbursement platform that automatically transfers funds from group purchasers of health care services to the medical home providers chosen by each patient; and an integrated clinical data management platform that collects outcomes and patient satisfaction data from various sources, and integrates these data into a single coherent view for outcomes analysis and quality monitoring.

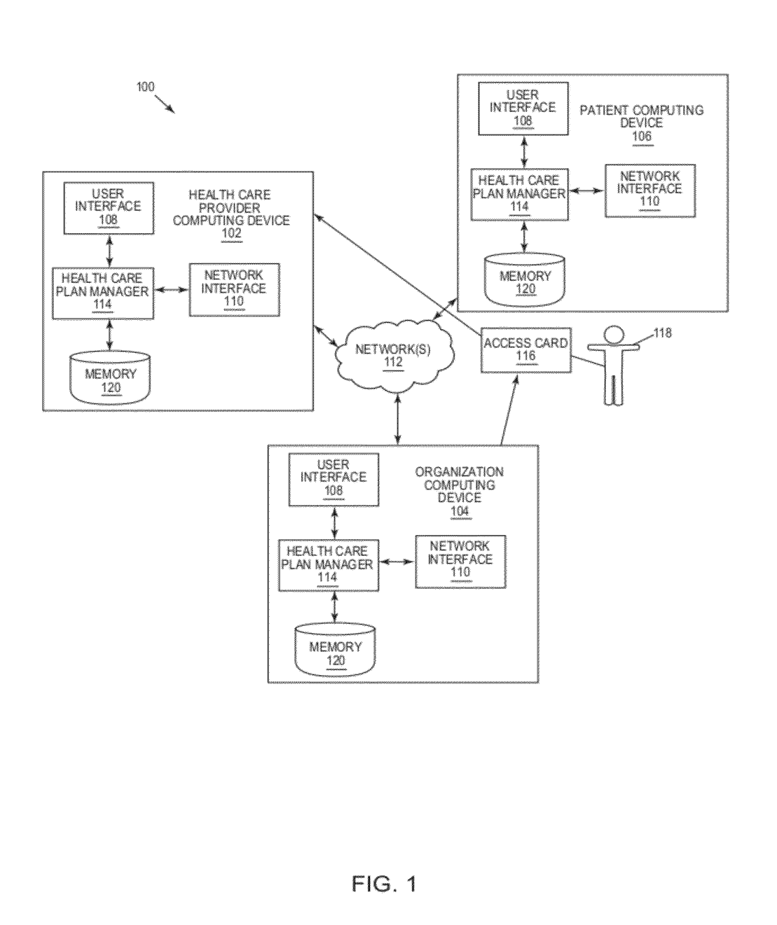

FIG. 1 illustrates a block diagram of an example computing system 100 for managing health care billing and payment in accordance with embodiments of the presently disclosed subject matter. It is noted that FIG. 1 and its corresponding description herein provides only one example implementation of the presently disclosed subject matter. The system may be implemented in any suitable manner and within any suitable system as will be understood by those of skill in the art. In this example, the system 100 includes a health care provider (HCP) computing device 102, an organization computing device 104, and a patient computing device 106. A computing device may be, for example, but not limited to, a suitable computer (e.g., desktop or laptop computer), a smartphone, a server, or any other suitable device having hardware, software, firmware, or combinations thereof.

The HCP computing device 102 may include a user interface 108 including one or more components configured to receive input from a user. The user interface 108 may also include one or more components configured to present information to a user. For example, the user interface 108 may include, but is not limited to, one or more of the following: a display, a mouse, a keyboard, and a printer. Also, the organization computing device 104 and the patient computing device 106 may each include a user interface 108.

Computing devices 102, 104, and 106 may each include a network interface 110 capable of communicating with each other and other devices. For example, the network interface 110 of computing device 102 is configured to communicate with the computing devices 104 and 106 via one or more networks 112, such as the Internet, a wireless network, local area network (LAN), or any other suitable network. The computing device 102 can be Internet-accessible and can interact with other devices using Internet protocols such as HTTP, HTTPS, and the like. Also, the computing devices 104 and 106 may each include a network interface 110.

The organization computing device 102 may be one or more computers or programs operated by or under control of a corporation or other legal entity having multiple employees. The computing device 102 may include accounting functionality for managing employee records and payment of health care services provided to the employees by one or more health care providers. The accounting functionality may be implemented by software, hardware, firmware, or combinations thereof residing on the computing device 104. Such functionality may be implemented partially or entirely by a health care plan manager 114.

The patient computing device 106 may be one or more computers or programs operated by individual patients. The computing device 106 may include accounting functionality for managing an individual's records for health care services and expenses. The accounting functionality may be implemented by software, hardware, firmware, or combinations thereof residing on the computing device 106. Such functionality may be implemented partially or entirely by a health care plan manager 114 of the computing device 106.

In an example method for managing health care billing and payment, authorized individuals of the organization and health care provider may negotiate terms of a health care billing and payment plan under which a schedule of health care services and associated subscription fees may be defined. Particularly, the plan may define fees at which the organization agrees to pay the health care provider for health care services provided to the organization's employees. The plan and computer-readable instructions for implementing the plan may be stored in whole or in part at the HCP computing device 102 and the organization computing device 104. The computer-readable instructions may be used for implementing methods in accordance with embodiments of the presently disclosed subject matter as described in more detail herein.

Subsequent to finalizing and defining the health care billing and payment plan, the organization may issue identification cards to each of its employees participating in the plan. The identification cards may be distributed from the organization to the employees when employment with the corporation begins or any time thereafter.

In an example, a health care provider may provide health care services to an employee having an identification card issued by an organization. To pay for the services entirely or in part, the employee may present the identification card to the health care provider. The identification card may be used to transact with the health care provider for the health care services provided to him or her. The health care provider may use the identification card to conduct a payment transaction between the organization and the health care provider such that the organization pays for the health care service in accordance with the health care billing and payment plan. For example, the transaction may be suitably implemented over an electronic communications system, such as the Internet or any other suitable communications network. Funds to pay for the health care services may be automatically transferred from a financial account of the organization to a financial account of the health care provider for payment of the health care service. As a result, coding, billing, and collection from third party payers may not be needed in the billing and payment process because the organization can receive bills directly from the health care provider and can directly submit payments to the health care provider.

In another embodiment of the presently disclosed subject matter, the previously-outlined steps of health care service terms negotiation, acceptance of billing terms, consumptions of services, and payment for services rendered may similarly be accomplished through the patient computing device 106 and the HCP computing device 102, and an identification card purchased by an individual patient.

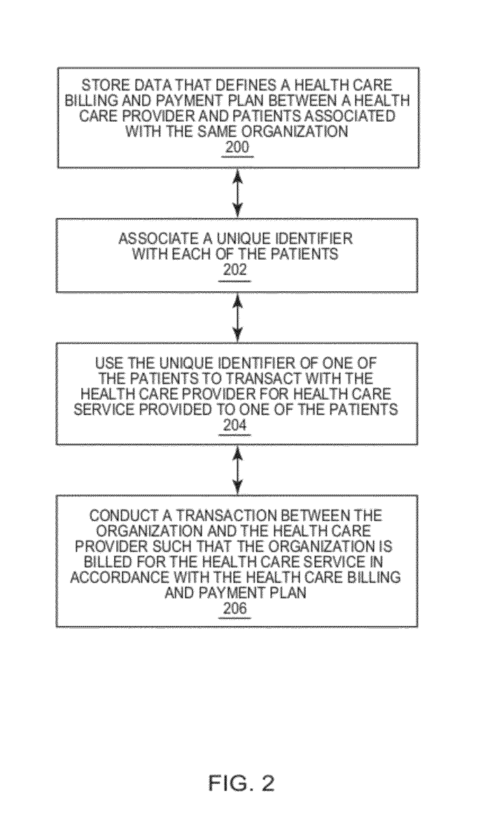

The health care plan manager 114 is configured to manage health care billing and payment in accordance with embodiments of the present disclosure. The manager 114 may accommodate fee for service POS transactions and subscription payments. The manager 114 may be implemented by software, hardware, firmware, or combinations thereof. As an example, FIG. 2 illustrates a flowchart of a method that may be implemented by a health care plan manager in accordance with embodiments of the present disclosure. The method of FIG. 2 is described with reference to FIG. 1; however, the method may be implemented within any suitable system.

Referring to FIG. 2, the method includes storing data that defines a health care billing and payment plan between a health care provider and patients associated with the same organization (step 200). In an example, the billing and payment plan defines fees at which the organization has agreed to pay the HCP for health care services provided to patients. Terms of the plan may have resulted from a negotiation between the organization and the HCP.

The method of FIG. 2 includes associating a unique identifier with each of the patients (step 202). For example, the health care billing and payment plan may associate a patient's information with a unique identifier. An identification card 116 as shown in the example of FIG. 1 may be provided to a patient 118 and may include an identifier associated with the patient 118. The identifier may be printed on the identification card 116 or stored in a magnetic stripe affixed to the identification card 116. The identifier may be a set of numerals, letters, or a combination thereof for uniquely identifying the patient among other patients. Identification cards may be distributed to the patient 118 and other patients from an organization, such as the patient's employer. In this way, the patient 118 may use the identification card when transacting for a service such that the patient can be associated with the plan. Further, for example, a memory 120 of the HCP computing device 108 or the organization computing device 104 may store data, such as a table, that associates the identifier with the patient 118 and other information related to the patient 118.

The method of FIG. 2 includes using the unique identifier of one of the patients to transact with the HCP for health care service provided to the patient (step 204). For example, the patient 118 may receive health care service from a physician employed by the HCP that owns and operates the HCP computing device 102. The patient 118 may present the identification card 116 to personnel of the HCP for payment of the health care service. In an example, the HCP's personnel or staff may use a keyboard of the user interface 108 to input the identification card's 116 identifier. In another example, a reader of the user interface 108 may read the identifier from a magnetic stripe on the identification card 116. The health care plan manager 114 of the computing device 102 may receive the identifier and use the identifier to access information of the patient 118 and the health care billing and payment plan associated with the patient. The identifier may be used to access information of the patient 118 and/or the plan data stored at the computing device 102 or computing device 104.

The method of FIG. 2 includes conducting a transaction between the organization and the HCP such that the organization is billed for the health care service in accordance with the health care billing and payment plan (step 206). For example, the computing device 102 of the HCP may communicate, to the computing device 104 of the organization, the identifier of the patient and an identifier of the service provided to the patient. In response, the manager 114 of the computing device 104 may check the identifiers against a plan stored in the memory 120 of the computing device 104 to confirm that a payment should be made to the HCP for the service provided to the patient 118. Subsequent to confirmation, payment for the service may be authorized. Payment may be made by any suitable process such as, for example, by issuance of a check to the HCP. In another example, payment may be made by transfer of funds from a financial account of the organization to a financial account of the HCP for payment of the health care service. The HCP may then receive payment from the organization and account for the payment. The HCP computing device 102 may include accounting functionality for tracking patient treatment and related billing and payment information. Accounting functionality may be implemented by software, hardware, firmware, or combinations thereof residing on the organization computing system 104.

In accordance with embodiments of the presently disclosed subject matter, outcome and patient satisfaction data may be collected about a health care provider. For example, such data may be collected from each patient. Outcome analysis and quality of service reports may be generated based on the data. Physicians may be scored based on their patients' progress. For example, the manager 114 of the computing device 102 or the computing device 104 may be configured to collect outcome and patient satisfaction data from the health care provider. Further, the manager 114 may generate outcome analysis and quality of service reports based on the data.

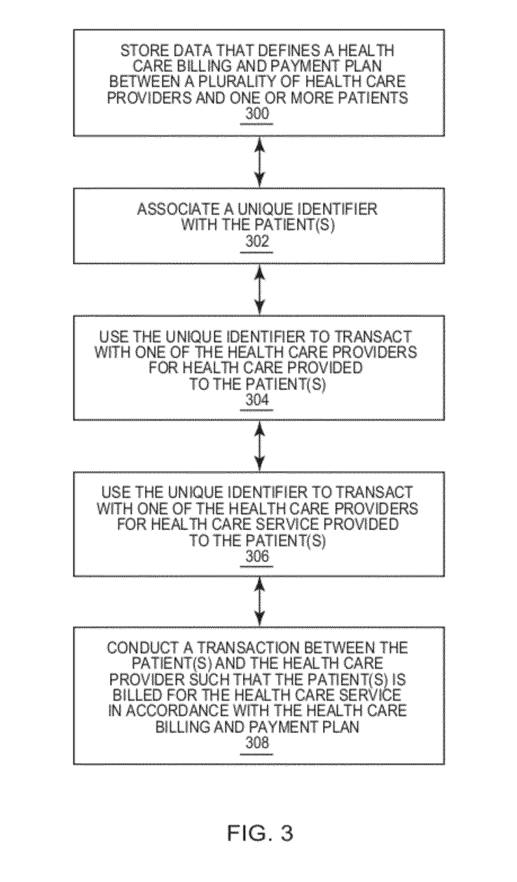

In accordance with embodiments of the present disclosure, FIG. 3 illustrates a flowchart of another method that may be implemented by a health care plan manager. The method of FIG. 3 is described with reference to FIG. 1; however, the method may be implemented within any suitable system. Referring to FIG. 3, the method includes storing data that defines a health care billing and payment plan between a plurality of health care providers and one or more patients (step 300). For example, the plan may be stored at the computing device 102 of the health care provider and/or the computing device 104 of the organization. The plan may define fees at which each patient has agreed to pay each health care provider for health care services provided to the respective patient. Each patient may be provided with a unique identification card including a unique identifier associated with the patient. The terms of the plan may have been negotiated by each patient with a representative of the health care providers.

The method of FIG. 3 includes associating a unique identifier with one of the patients (step 302). For example, the plan may associate a patient's information with a unique identifier. Such information may be stored in the memory 120 of one or both of the HCP computing device 108 or the organization computing device 104.

The method of FIG. 3 includes using the unique identifier to transact with one of the health care providers for health care service provided to the patient (step 304). For example, the patient 118 may receive health care service from a physician employed by the HCP that owns and operates the HCP computing device 102. The patient 118 may present the identification card 116 to personnel of the HCP for payment of the health care service. In an example, the HCP's personnel or staff may use a keyboard of the user interface 108 to input the identification card's 116 identifier. In another example, a reader of the user interface 108 may read the identifier from a magnetic stripe on the identification card 116. The health care plan manager 114 of the computing device 102 may receive the identifier and use the identifier to access information of the patient 118 and the health care billing and payment plan associated with the patient. The identifier may be used to access information of the patient 118 and/or the plan data stored at the computing device 102 or computing device 104.

The method of FIG. 3 includes conducting a transaction between the patient and the health care provider such that the patient is billed for the health care service in accordance with the health care billing and payment plan (step 306). For example, the computing device 102 of the HCP may check the identifier against a plan stored in the memory 120 of the computing device 102 to confirm that a payment should be made to the HCP for the service provided to the patient 118. Subsequent to confirmation, payment for the service may be made by the patient 118 in accordance with the plan. Payment may be made by any suitable process such as, for example, by issuance of a check to the HCP. In another example, payment may be made by transfer of funds from a financial account of the patient 118 to a financial account of the HCP for payment of the health care service. The HCP may then receive payment from the organization and account for the payment.

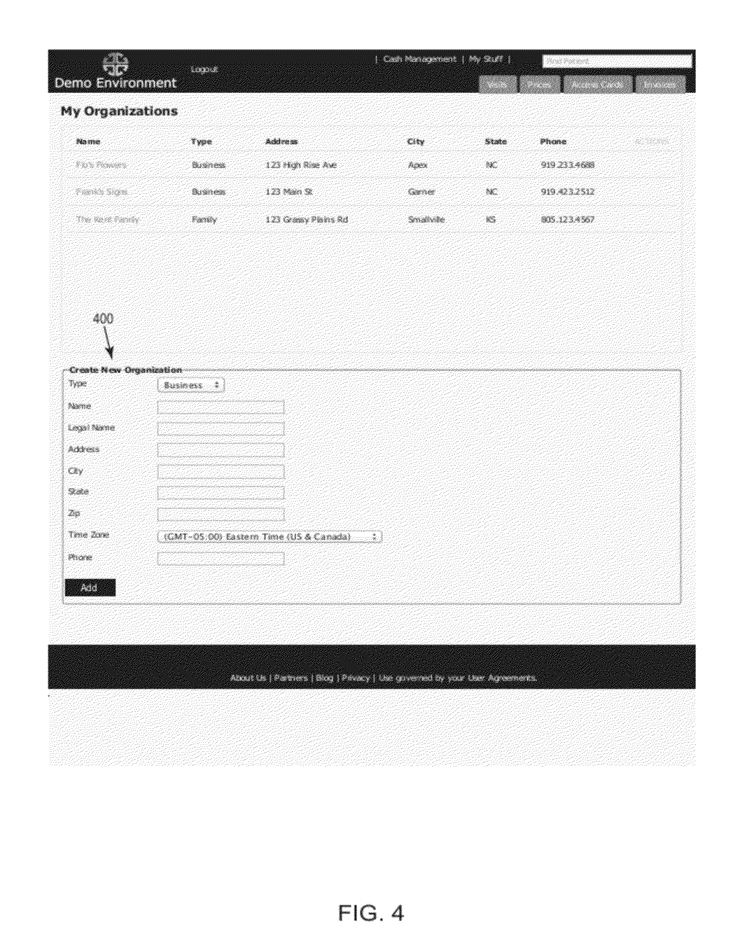

FIGS. 4-11 depict various example screenshots presented by a display of a computing device of a health care provider in accordance with embodiments of the present disclosure. Particularly, FIG. 4 depicts an example screenshot for providing interface with information of organizations associated with the health care provider. Referring to FIG. 4, the interface shows that the health care provider has established health care billing and payment plans with three organizations named: Flo's Flowers, Frank's Signs, and The Kent Family. Flo's Flowers and Frank's Signs are businesses, and The Kent Family is a family. New organizations may be added under the “Create New Organization” section 400.

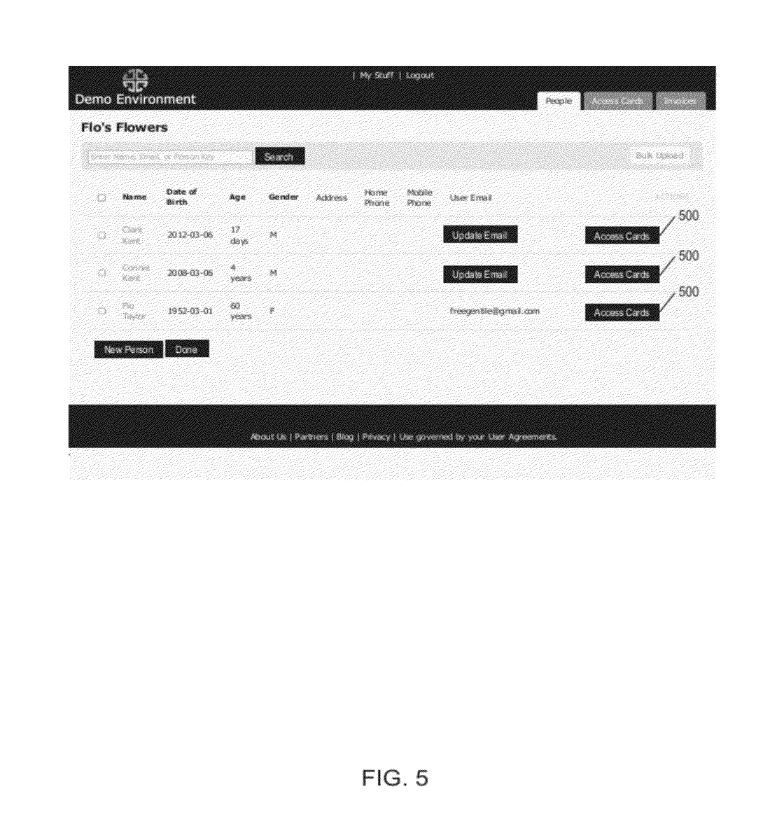

A user may select one of the organization names shown in FIG. 4 to display additional information. For example, FIG. 5 depicts an example screenshot for providing interface with information of a specific organization associated with the health care provider. In this example, the user has selected Flo's Flowers. Referring to FIG. 5, information for three individuals is displayed. Another individual may be added by selection of the “New Person” icon.

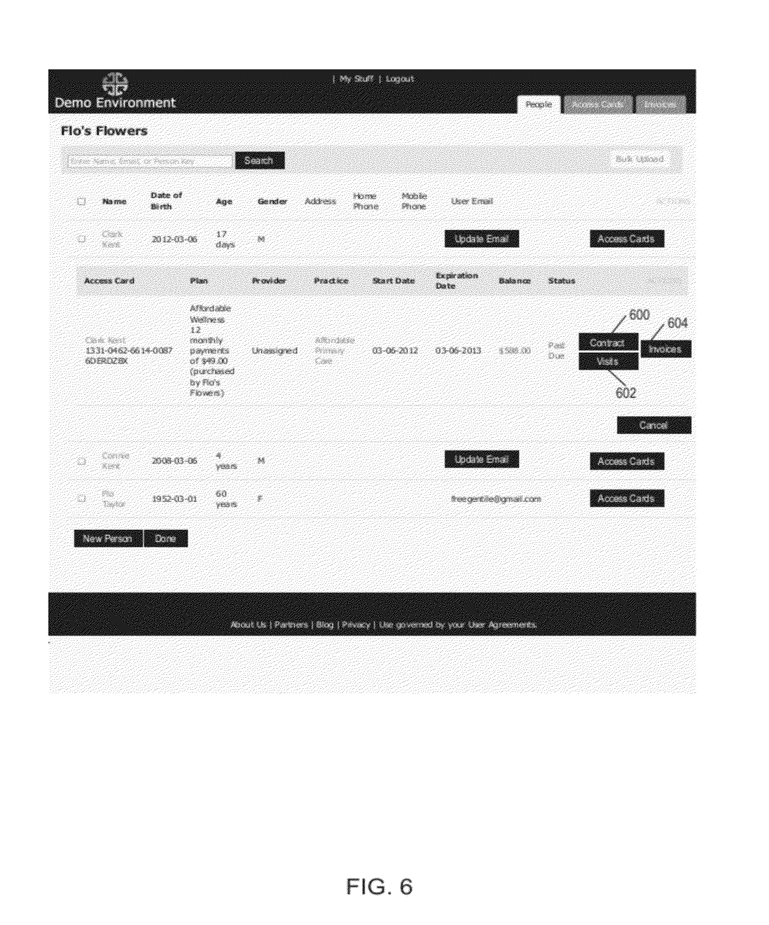

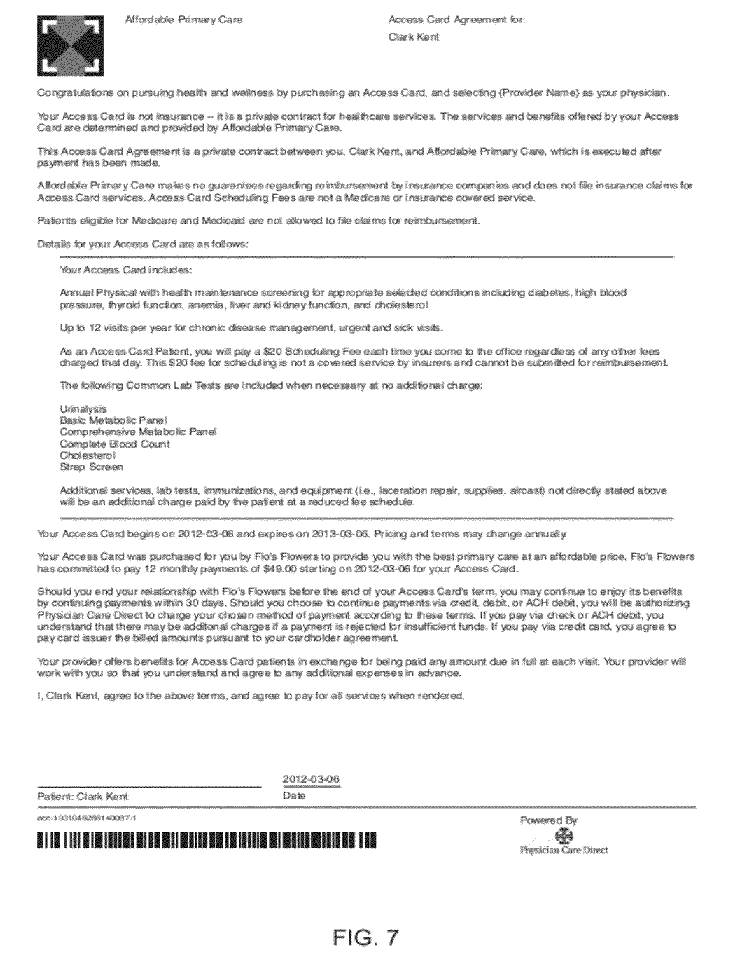

Additional information for an individual may be presented by user selection of the “Access Cards” or “Identification Cards” icon 500 associated with the respective individual. FIG. 6 depicts an example screenshot presented subsequent to the Cards icon 500 being selected for one of the individuals shown in FIG. 5. Referring to FIG. 6, information about the individual's plan, visits, and invoices may be presented by selection of the icons 600, 602, and 604, respectively. FIG. 7 depicts an example screenshot of a health care billing and payment plan between an individual and an organization. The screenshot of FIG. 7 may be presented in response to selection of the icon 600 shown in FIG. 6.

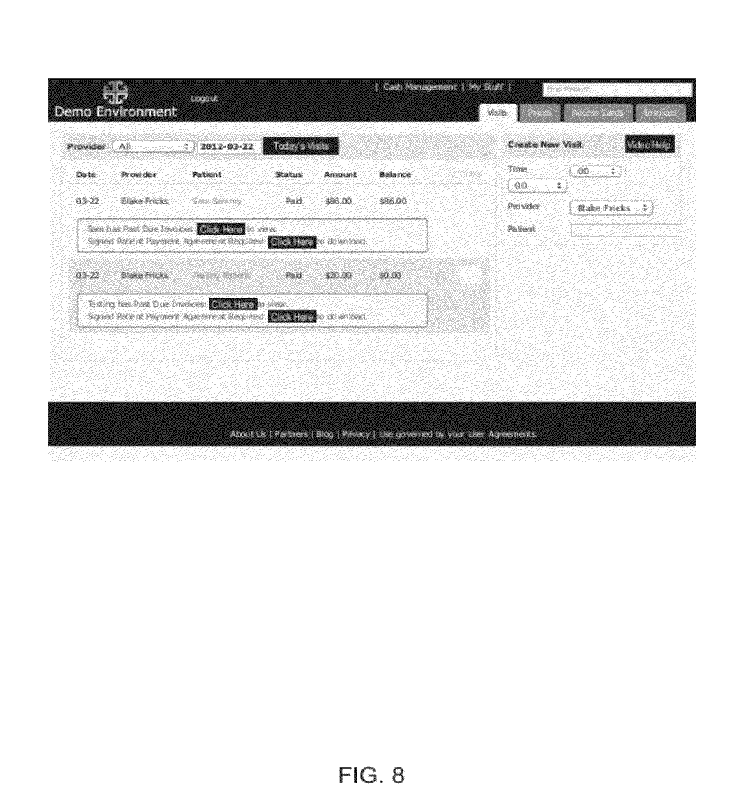

FIG. 8 depicts an example screenshot of visits scheduled with a health care provider. A user may interact with the displayed interface to view information about visits on different days and to view information about identified patients.

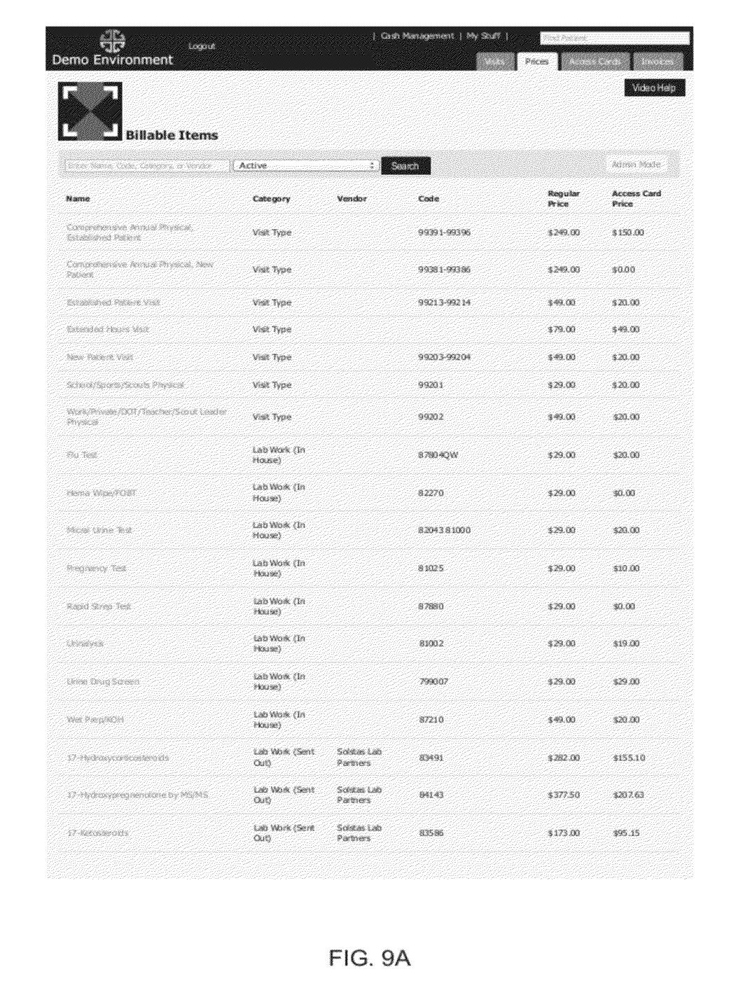

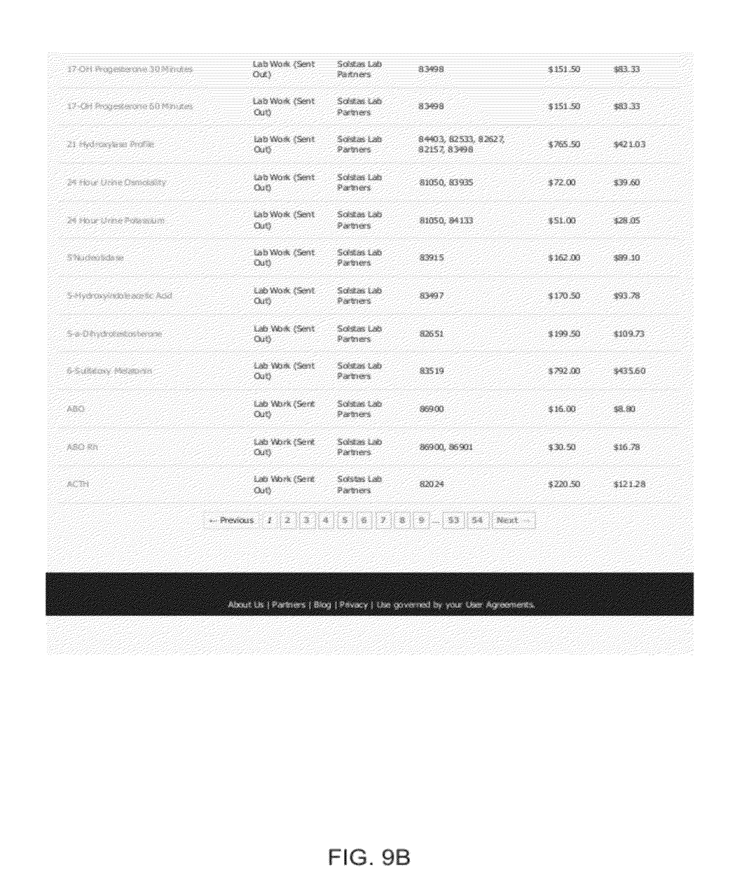

FIG. 9 depicts an example screenshot of billable items associated with a plan of a health care provider. A user may interact with the displayed interface to view information about identified items.

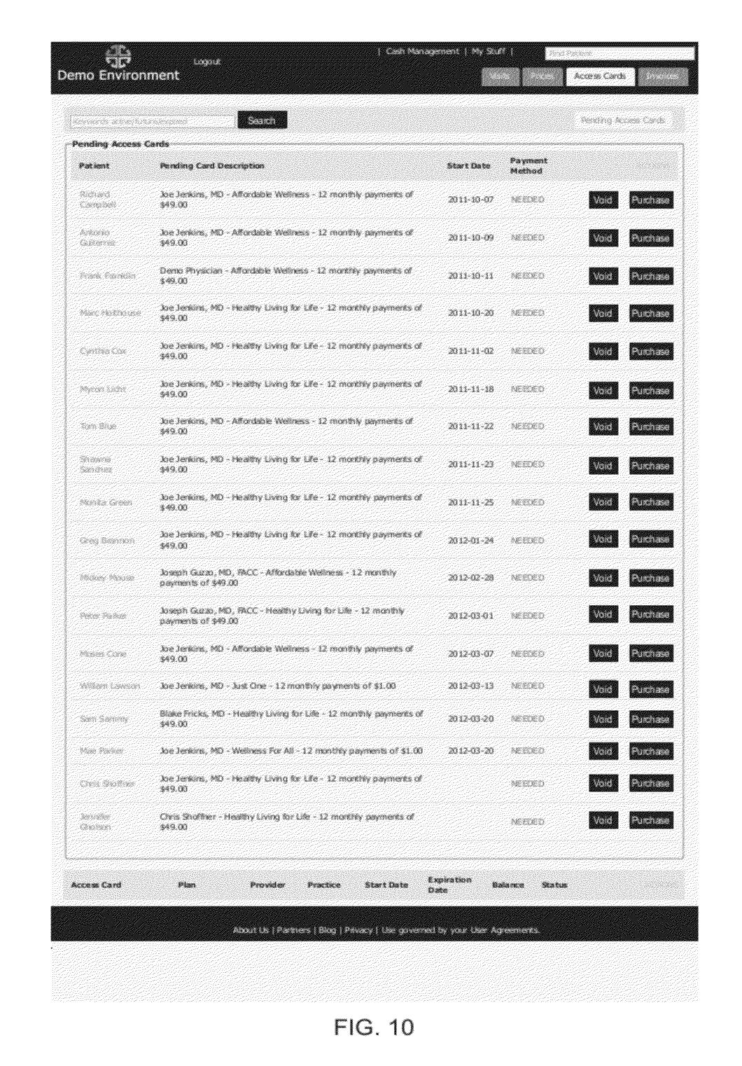

FIG. 10 depicts an example screenshot of pending identification cards associated with a plan of a health care provider. A user may interact with the displayed interface to view information about identified identification cards.

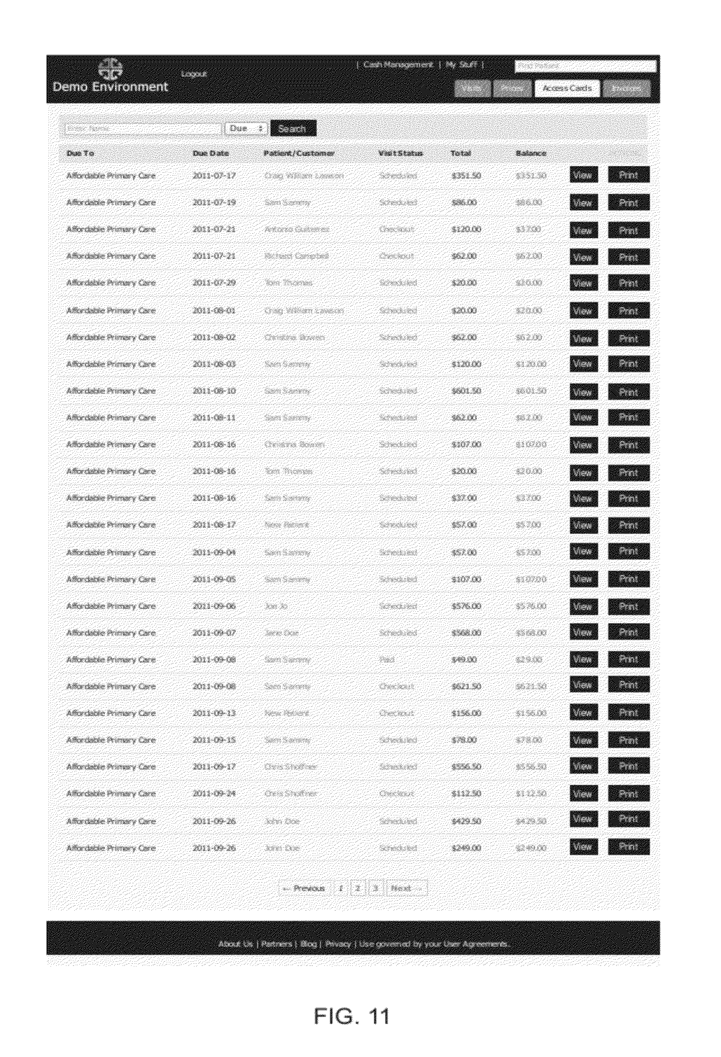

FIG. 11 depicts an example screenshot of invoices associated with a plan of a health care provider. A user may interact with the displayed interface to view information about an identified patient/customer.

As will be appreciated by one skilled in the art, aspects of the presently disclosed subject matter may be embodied as a system, method or computer program product. Accordingly, aspects of the presently disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the presently disclosed subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the presently disclosed subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the presently disclosed subject matter are described below with reference to flowchart illustrations and/or diagrams of methods, apparatus (systems) and computer program products according to embodiments of the presently disclosed subject matter. For example, aspects of the presently disclosed subject matter are described with reference to the diagram of FIG. 1. It will be understood that each block of the flowchart illustrations and/or diagrams, and combinations of blocks in the flowchart illustrations and/or diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the presently disclosed subject matter. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the presently disclosed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the presently disclosed subject matter has been presented for purposes of illustration and description, but is not intended to be exhaustive or limited to the presently disclosed subject matter in the form disclosed. Many modifications and variations will be apparent to those of ordinary skill in the art without departing from the scope and spirit of the presently disclosed subject matter. The embodiment was chosen and described in order to best explain the principles of the presently disclosed subject matter and the practical application, and to enable others of ordinary skill in the art to understand the presently disclosed subject matter for various embodiments with various modifications as are suited to the particular use contemplated.

What is claimed is:

1. A method comprising:
storing data that defines a health care billing and payment plan between a health care provider and patients associated with the same organization;
associating a unique identifier with each of the patients;
using the unique identifier of one of the patients to transact with the health care provider for health care service provided to the one of the patients; and
conducting a transaction between the organization and the health care provider such that the organization is billed for the health care service in accordance with the health care billing and payment plan.

2. The method of claim 1, further comprising providing to each of the patients a unique identification card including the unique identifier associated with the respective patient.

3. The method of claim 2, wherein providing the identification card to the patients includes distributing the identification cards from the organization to the patients.

4. The method of claim 1, wherein the one or more patients are employed by the organization.

5. The method of claim 1, wherein the health care billing and payment plan defines fees at which the organization has agreed to pay the health care provider for health care services provided to the patients.

6. The method of claim 1, further comprising negotiating terms of the plan.

7. The method of claim 1, wherein conducting the transaction includes transferring funds from a financial account of the organization to a financial account of the health care provider for payment of the health care service.

8. The method of claim 1, further comprising collecting outcome and patient satisfaction data from the health care provider.

9. The method of claim 8, further comprising generating outcome analysis and quality of service reports based on the data.

10. The method of claim 1, further comprising receiving payment from the organization for the billed health care service.

11. The method of claim 1, further comprising using a processor for implementing the steps of storing the data, associating the unique identifier, using the unique identifier, and conducting the transaction.

12. A computing system comprising:
a memory configured to store data that defines a health care billing and payment plan between a health care provider and patients associated with the same organization; and
a health care plan manager configured to:
associate a unique identifier with each of the patients;
use the unique identifier of one of the patients to transact with the health care provider for health care service provided to the one of the patients; and
conduct a transaction between the organization and the health care provider such that the organization is billed for the health care service in accordance with the health care billing and payment plan.

13. A method comprising:
storing data that defines a health care billing and payment plan between a plurality of health care providers and at least one patient;
associating a unique identifier with the at least one patient;
using the unique identifier to transact with one of the health care providers for health care service provided to the at least one patient; and
conducting a transaction between the at least one patient and the one of the health care providers such that the at least one patient is billed for the health care service in accordance with the health care billing and payment plan.

14. The method of claim 13, further comprising providing to the at least one patient a unique identification card including the unique identifier associated with the at least one patient.

15. The method of claim 13, wherein the health care billing and payment plan defines fees at which the patient has agreed to pay the health care provider for health care services provided to the patient.

16. The method of claim 13, further comprising negotiating terms of the plan.

17. The method of claim 13, wherein conducting the transaction includes transferring funds from a financial account of the at least one patient to a financial account of one of the health care providers for payment of the health care service.

18. The method of claim 13, further comprising collecting outcome and patient satisfaction data from one of the health care providers.

19. The method of claim 18, further comprising generating outcome analysis and quality of service reports based on the data.

20. The method of claim 13, further comprising receiving payment from the at least one patient for the billed health care service.

21. A computing system comprising:
a memory configured to store data that defines a health care billing and payment plan between a plurality of health care providers and at least one patient; and
a health care plan manager configured to:
associate a unique identifier with the at least one patient;
use the unique identifier to transact with one of the health care providers for health care service provided to the at least one patient; and
conduct a transaction between the at least one patient and the one of the health care providers such that the at least one patient is billed for the health care service in accordance with the health care billing and payment plan.
